(19) United States
(12) Patent Application Publication
(10) Pub. No.: US 2026/0345405 A1
(43) Pub. Date: Nov. 5, 2026

(54) ASSISTIVE TOILET CHAIR

(71) Applicant: CHIEN-CHUNG SU, Taichung City (TW)

(72) Inventors: CHIEN-CHUNG SU, Taichung City (TW); CHEN-CHUAN CHEN, Taichung City (TW); CHIH-WEN KUAN, Taichung City (TW)

(21) Appl. No.: 19/487,410

(22) PCT Filed: May 30, 2023
(86) PCT No.: PCT/CN2023/097153

§ 371 Date: Nov. 24, 2025

(51) Int. Cl. A61G 5/14; A61G 5/10

(52) U.S. Cl. CPC A61G 5/14; A61G 5/1002

(57) ABSTRACT

An assistive toilet chair includes a chair frame, a seat, and a controlling device. The seat includes an immovable portion fixed to the chair frame and a movable portion pivotally connected to the chair frame. The controlling device has a control pedal, a power source, and a driver. The control pedal, when being pressed, controls the power source to activate the driver to drive the movable portion to pivotally swing between a sitting position and a standing position. When being in the sitting position, the movable portion works with the immovable portion to form a complete seat for a user to sit thereon. When being in the standing position, the movable portion separates from the immovable portion to prop up the user.

### TECHNICAL FIELD

The present invention relates to medical aid equipment, and more particularly to an assistive toilet chair that has separatable seat portions for facilitating a user in standing up by eliminating interference from limitation caused by traditional one-piece seat structures.

### DESCRIPTION OF RELATED ART

There are toilet chairs developed to assist care receivers in easy defecation. However, with such an existing product, when a user, i.e., a care receiver, needs cleaning after defecation, the user has to stand up and stick his/her bottom out or bend his/her back down for a caregiver to become close to his/her body enough to reach the user's body parts that need cleaning. In such a posture, the caregiver may have difficulty in supporting and cleaning the user without causing physical discomfort to the user.

In order to address the foregoing issue, some toilet chairs with stand-assisting functions have been introduced. For example, Taiwan Patent No. M291289 has disclosed a stand-assisting chair that comprises a lifting-and-tilting device, a toilet seat, and a seat frame. The lifting-and-tilting device is installed below the toilet seat. The toilet seat is supported by the seat frame. The lifting-and-tilting device serves to lift and tilt the seat frame and the toilet seat, so as to provide a user sitting in the chair with assistance in standing up and/or sitting down.

### SUMMARY OF THE INVENTION

### Technical Issue

When a user stands up with the help of the known chair, the toilet seat formed as a closed circle encircles the hips of the users therein, and the clearance between the lifted toilet seat and the chair body is narrow.

Thus, in order to clean the hips of the user for defecation nursing, the caregiver has to first thrust his/her hand hardly into the gap between the body of the user and the toilet seat, and may even have to move the user to make a bare room for him/her to perform the cleaning work.

### Solution to Problems

For preventing the foregoing awkward situations, the present invention provides an assistive toilet chair, which eliminates limitation caused by traditional one-piece seat structures by using separatable seat portions that facilitate a user in standing up and facilitate a caregiver in doing defecation nursing for the user.

In one embodiment of the present invention, the assistive toilet chair comprises: a chair frame; a seat, being placed on the chair frame for a user to sit thereon, the seat including an immovable portion and a movable portion, the immovable portion being fixedly connected to a rear side of the chair frame, the movable portion being pivotally connected to a front side of the chair frame, the movable portion and the immovable portion being separatably combined, and the immovable portion and the movable portion being in matching U-like shapes with openings thereof facing each other; and a controlling device, being attached to the chair frame, the controlling device controlling the movable portion to pivotally swing and move between a sitting position and a standing position; the controlling device having a control pedal, a power source, and a driver, the control pedal being attached to a lower part of the front side of the chair frame and being connected to the power source, and the driver being connected between the power source and the movable portion of the seat, so that when the control pedal is pressed, the controlling device controls the power source to activate the driver to drive the movable portion to pivotally swing, wherein when the movable portion is in the sitting position, the movable portion and the immovable portion combine to form the complete seat for the user to sit thereon, and when the movable portion is in the standing position, the movable portion separates from the immovable portion and props up the user to stand up, so that the user has hips thereof exposed at the opening of the movable portion.

In one embodiment, the control pedal has a first tread portion and a second tread portion, in which when the first tread portion is pressed, the controlling device controls the power source to activate the driver to drive the movable portion to pivotally swing from the sitting position to the standing position, and when the second tread portion is pressed, the controlling device controls the power source to activate the driver to drive the movable portion to pivotally swing from the standing position to the sitting position.

In one embodiment, the power source is a pneumatic valve and the driver is a pneumatic cylinder, in which a first tube and a second tube are arranged between the power source and the driver, so that when the first tread portion is pressed, the first tube communicates with the driver, whereby the driver props up the movable portion and the movable portion pivotally swings from the sitting position to the standing position, and when the second tread portion is pressed, the second tube communicates with the driver, whereby the driver makes the movable portion pivotally swing back to the sitting position from the standing position.

In one embodiment, a first check valve is arranged between the power source and the first tube, and a second check valve is arranged between the power source and the second tube.

In one embodiment, the control pedal further has a first press member and a second press member, in which the first press member is arranged between the first tread portion and the first check valve, and the second press member is arranged between the second tread portion and the second check valve.

In one embodiment, a chair back is attached to the rear side of the chair frame, in which the opening of the movable portion faces the chair back.

In one embodiment, the present invention further has two primary wheels and two auxiliary wheels, wherein the two primary wheels are coaxially attached to two outer laterals of the chair frame and are close to the rear side of the chair frame, and the two auxiliary wheels are coaxially attached to the two outer laterals of the chair frame and are close to the front side of the chair frame.

In one embodiment, the chair frame has two braces and a crossbar, and the crossbar has two ends thereof connected to front sides of the two braces, so that the two primary wheels and the two auxiliary wheels are attached to the two braces, respectively, and wherein the movable portion has a bottom surface that is provided with a first hinge and a second hinge, in which the first hinge is located opposite to the opening of the movable portion and is pivotally connected to the crossbar, while the second hinge is pivotally connected to the driver.

In one embodiment, a connecting component is arranged between the driver and the movable portion, and has a universal joint and a link, wherein the universal joint is connected between the driver and the link, and the link is pivotally connected between the universal joint and the second hinge.

In one embodiment, the present invention further has two anti-tumble members and two retaining members, each of the anti-tumble members having one end thereon pivotally connected to the front side of the chair frame and an opposite end configured to prop on the ground, and the two retaining members being attached to the front side of the chair frame and close to a top surface of the chair frame, so that the two retaining members fittingly receive the two anti-tumble members.

With the configuration discussed previously, the present invention can have the movable portion and the immovable portion combined or separated under the control of the controlling device. When a user needs cleaning such as defecation nursing, he/she can be propped up by the movable portion and stand up easily. At this time, the body parts of the user to be cleaned are exposed and accessible to a caregiver, thereby enabling easy and comfortable cleaning. The present invention thereby addresses issues of the prior-art devices about difficult operation of user cleaning.

### DRAWINGS DESCRIPTION

FIG. 1 is a perspective view of the present invention, showing that two anti-tumble members propping on the ground;

FIG. 2 is another perspective view of the present invention, showing that the two anti-tumble members retracted to two retaining members;

FIG. 3 is a circuit diagram of the controlling device according to the present invention;

FIG. 4 is an applied view of the present invention, illustrating that the controlling device controls the movable portion to pivotally swing to the standing position;

FIG. 5 is another applied view of the present invention, illustrating that the controlling device controls the movable portion to pivotally swing to the sitting position;

FIG. 6 is yet another applied view of the present invention, illustrating that the movable portion is in the sitting position for a user to sit therein;

FIG. 7 is still another applied view of the present invention, illustrating that the movable portion is in the standing position to aid the user in standing up and facilitate the caregiver in doing defecation nursing for the user;

FIG. 8 is a top view of FIG. 7; and

FIG. 9 is a further applied view of the present invention, illustrating that the movable portion pivotally swings to the sitting position from the standing position, with the user sitting therein.

Wherein, 1: user; 2: user's hips; 3: caregiver; 100: assistive toilet chair; 10: chair frame; 11: chair back; 12: retaining member; 13: brace; 14: crossbar; 20: anti-tumble member; 30: seat; 31: immovable portion; 32: movable portion; 321: first hinge; 322: second hinge; 40: controlling device; 41: control pedal; 411: first tread portion; 412: second tread portion; 413: first press member; 414: second press member; 42: power source; 43: driver; 431: outer sleeve; 432: inner shaft; 44: connecting component; 441: universal joint; 442: link; 45: first tube; 4l : second tube; 47: first check valve; 48: second check valve; 50: primary wheel; 60: auxiliary wheels.

### IMPLEMENTING THE PREFERRED EMBODIMENTS OF THE INVENTION

The following preferred embodiments when read with the accompanying drawings are made to clearly exhibit the above-mentioned and other technical contents, features and effects of the present invention. Through the exposition by means of the specific embodiments, people would further understand the technical means and effects the present invention adopts to achieve the above-indicated objectives. However, the accompanying drawings are intended for reference and illustration, but not to limit the present invention and are not made to scale.

The following description, in conjunction with the accompanying drawings and preferred embodiments, is set forth as below to illustrate the present invention in detail. It is to be noted that spatial descriptions, such as “up,” “down,” “front,” “back,” “left,” “right,” “top,” “bottom,” “inside,” “outside” and so forth, are indicated with respect to the orientation shown in the figures unless otherwise specified. It should be understood that the spatial descriptions used herein are for purposes of illustration only, and that practical implementations of the structures described herein can be spatially arranged in any orientation or manner, provided that the merits of embodiments of this disclosure are not deviated by such arrangement.

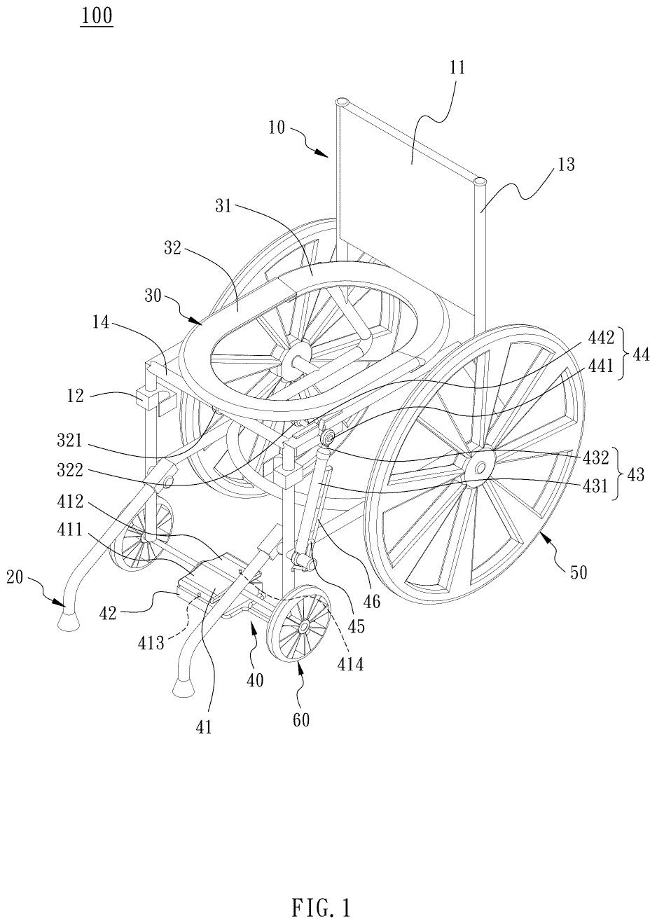

Referring to FIG. 1 through FIG. 9, an assistive toilet chair 100 of the present invention comprises the following components:.

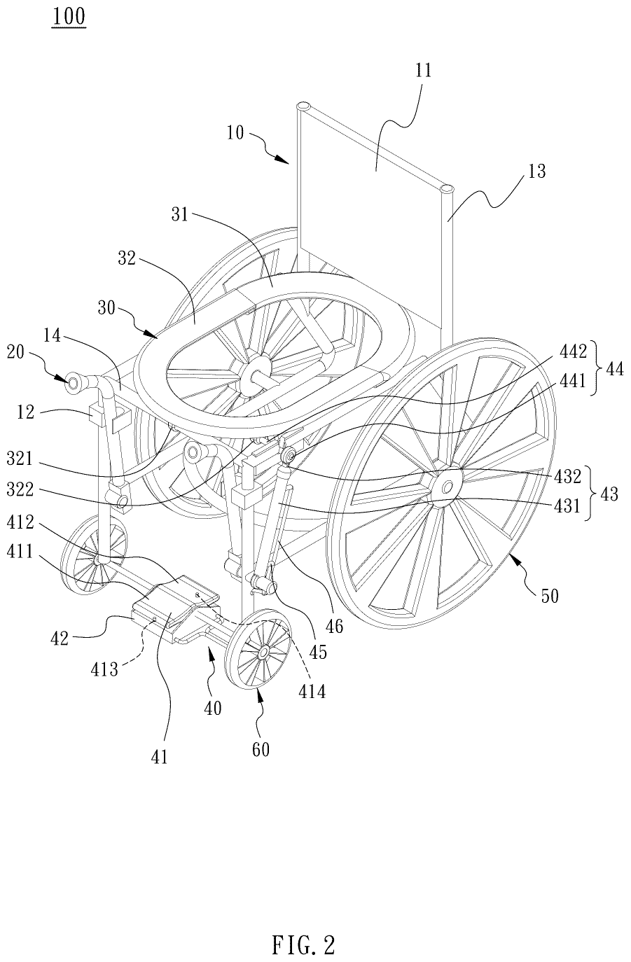

The assistive toilet chair 100 has a chair frame 10. The chair frame 10 has a chair back 11 attached to its rear side and has two retaining members 12 attached to its front side. The two retaining members 12 are close to a top surface of the chair frame 10. The chair frame 10 has two braces 13 and a crossbar 14. The crossbar 14 has its two ends each laterally connected to the front side of the corresponding brace 13. The two retaining members 12 are each attached to the corresponding brace 13. In the embodiment of the present invention, the crossbar 14 is lengthwise parallel to the chair back 11. The two retaining members 12 each define a notch, as shown in FIG. 1 and FIG. 2.

The assistive toilet chair 100 has two anti-tumble members 20. Each of the anti-tumble members 20 has its one end pivotally connected to the front side of the corresponding brace 13 and has its opposite end configured to prop on the ground. When the two anti-tumble members 20 are retracted, they are fit in the notches of the two retaining members 12, as shown in FIG. 2. When the two anti-tumble members 20 are pivotally pulled out of the notches of the retaining members 12 by an external force, each of the two anti-tumble members 20 props on the ground to prevent the assistive toilet chair 100 from tumble, as shown in FIG. 1.

The assistive toilet chair 100 has a seat 30. The seat 30 is placed on the chair frame 10 so that a user 1 can sit on it. The seat 30 has an immovable portion 31 and a movable portion 32. The immovable portion 31 is fixedly connected to the rear side of the chair frame 10. The movable portion 32 is pivotally connected to the front side of the chair frame 10. The movable portion 32 and the immovable portion 31 are separatably combined. Therein, the movable portion 32 has its bottom surface provided with a first hinge 321 and a second hinge 322. The first hinge 321 is located opposite to the opening of the movable portion 32 and is pivotally connected to the crossbar 14, as shown in FIG. 1 and FIG. 2.

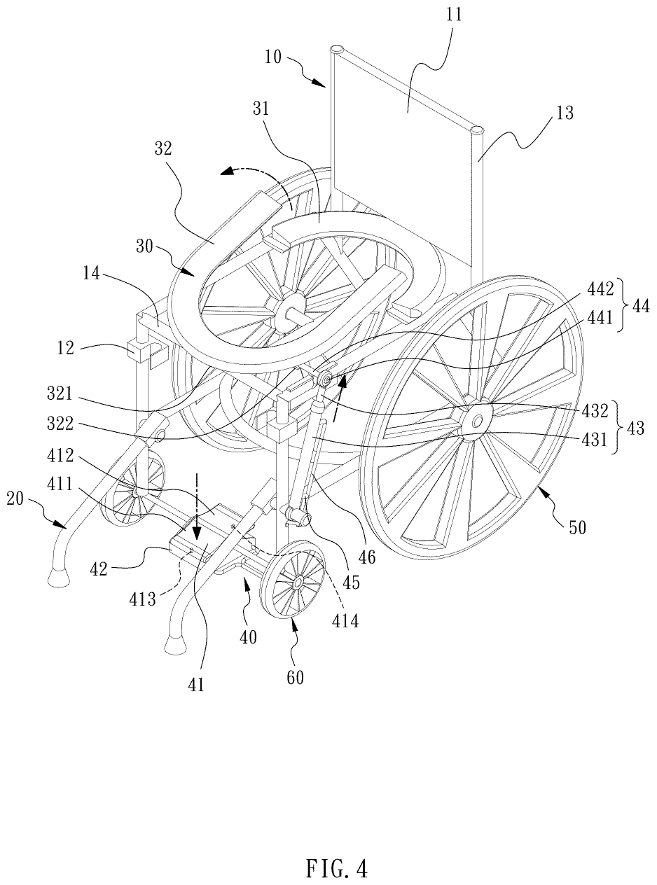

Furthermore, the immovable portion 31 is generally U-shaped and the movable portion 32 is of a matching U-like shape open to the chair back 11. When the two seat portions 31, 32 are combined, their openings combined together, as shown in FIG. 1, FIG. 2, and FIG. 4.

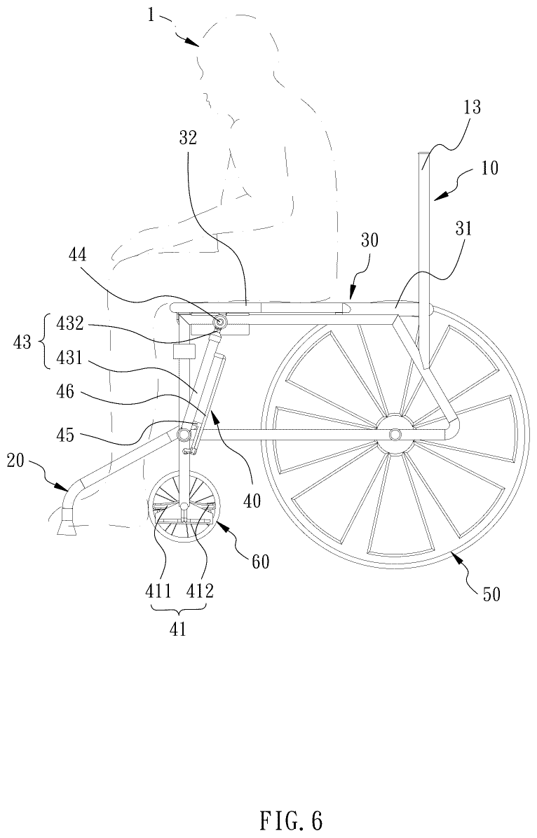

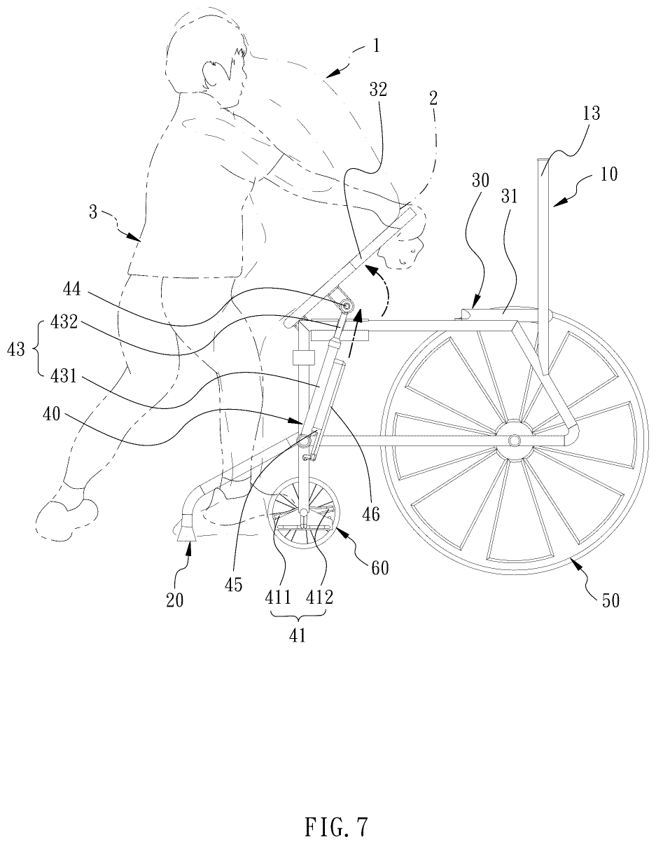

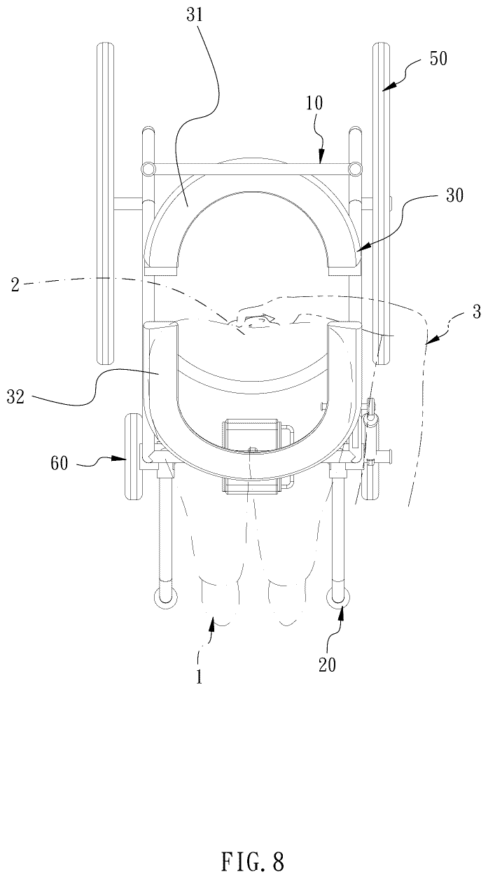

The assistive toilet chair 100 has a controlling device 40. The controlling device 40 is attached to the chair frame 10 and serves to control the movable portion 32 to pivotally swing between a sitting position and a standing position. When the movable portion 32 is in the sitting position, the movable portion 32 and the immovable portion 31 are combined for the user 1 to sit thereon, as shown in FIG. 1 and FIG. 6. When the movable portion 32 is in the standing position, the movable portion 32 separates from the immovable portion 31 and props up the user 1 to stand up. At this time, the user 1 has his/her hips 2 exposed at the opening of the movable portion 32, as shown in FIG. 7 and FIG. 8.

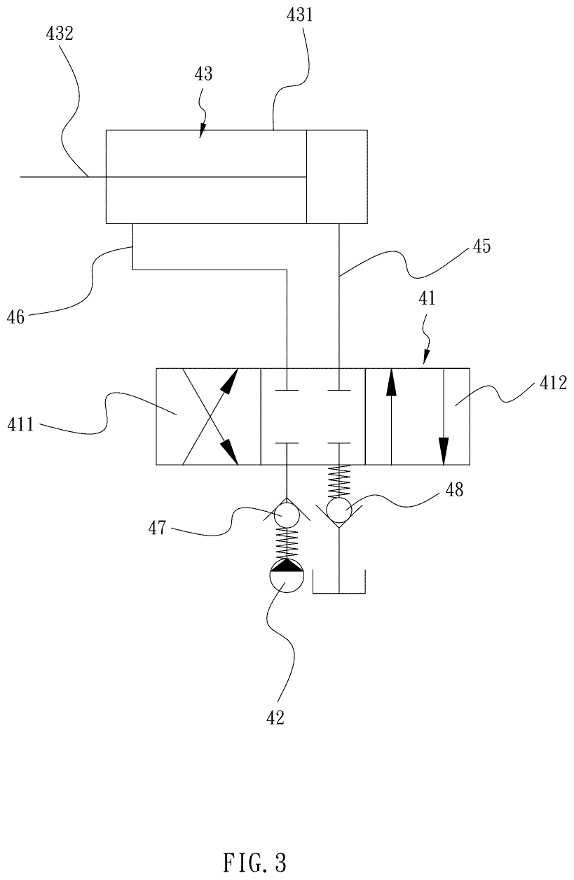

The controlling device 40 has a control pedal 41, a power source 42, and a driver 43. The control pedal 41 is attached to the lower part of the front side of the chair frame 10 and is connected to the power source 42. The driver 43 is connected between the power source 42 and the movable portion 32 of the seat 30. The second hinge 322 of the movable portion 32 is pivotally connected to the driver 43. The control pedal 41 is configured to, in response to an external pressing force, control the power source 42 to activate the driver 43 to drive the movable portion 32 to pivotally swing, as shown in FIG. 3 through FIG. 5.

Meanwhile, the driver 43 and the movable portion 32 are connected by a connecting component 44. The connecting component 44 includes a universal joint 441 and a link 442. The universal joint 441 is connected between the driver 43 and the link 442. The link 442 is pivotally connected between the universal joint 441 and the second hinge 322, as shown in FIG. 1 and FIG. 2.

In addition, a first tube 45 and a second tube 46 are arranged between the power source 42 and the driver 43. A first check valve 47 is arranged between the power source 42 and the first tube 45. A second check valve 48 is arranged between the power source 42 and the second tube 46. Therein, the control pedal 41 has a first tread portion 411, a second tread portion 412, a first press member 413 and a second press member 414. The first press member 413 is arranged between the first tread portion 411 and the first check valve 47. The second press member 414 is arranged between the second tread portion 412 and the second check valve 48, as shown in FIG. 1 through FIG. 3. In the embodiment of the present invention, the power source 42 is a pneumatic valve, and the driver 43 is a pneumatic cylinder. The driver 43 has an outer sleeve 431 and an inner shaft 432. The power source 42 supplies pressurized gas to the outer sleeve 431 through the first tube 45. Alternatively, pressurized gas in the outer sleeve 431 enters a gas chamber of the power source 42 though the second tube 46. The configuration allows the inner shaft 432 to stretch out the outer sleeve 431 or retract into the outer sleeve 431.

Referring to FIG. 3 and FIG. 4, when the first tread portion 411 of the control pedal 41 is pressed by an external force, the first check valve 47 communicates with the first tube 45, so that the first tube 45 communicates with the driver 43, whereby the power source 42 supplies pressurized gas to the outer sleeve 431 of the driver 43 through the first tube 45. As a result, the inner shaft 432 is driven to stretch out and drives the connecting component 44 to pivotally swing the movable portion 32 from the sitting position to the standing position.

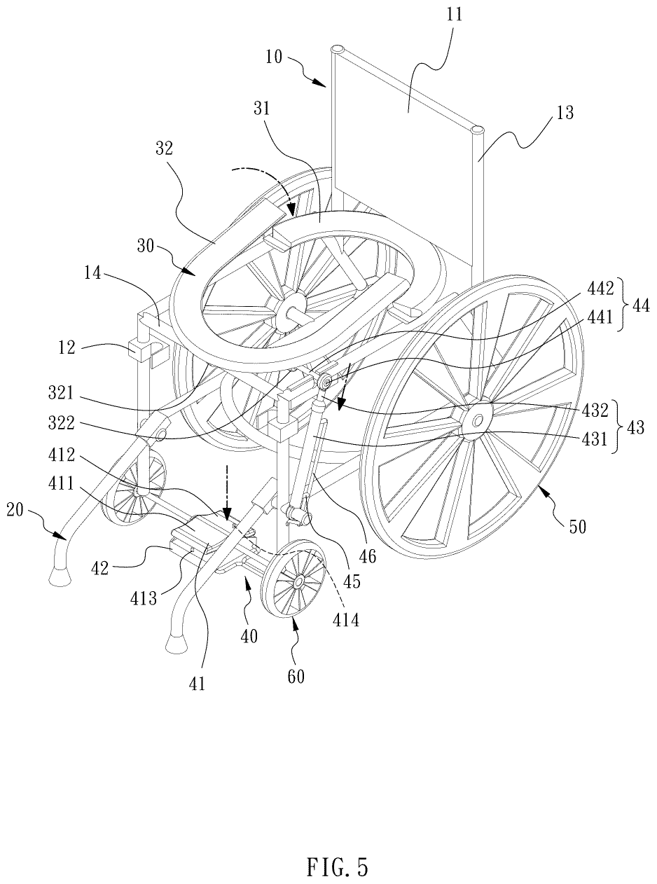

Referring to FIG. 3 and FIG. 5, when the second tread portion 412 of the control pedal 41 is pressed by an external force, the second check valve 48 communicates with the second tube 46, so that the second tube 46 communicates with the driver 43, whereby pressurized gas in the outer sleeve 431 enters the gas chamber of the power source 42 through the second tube 46. As a result, the inner shaft 432 is driven to retract and drives the connecting component 44 to pivotally swing the movable portion 32 from the standing position back to the sitting position.

The assistive toilet chair 100 has two primary wheels 50 that are coaxially attached to two outer laterals of the chair frame 10, so that the two primary wheels 50 are close to the rear side of the chair frame 10. Particularly, the two primary wheels 50 are each attached to the corresponding brace 13, as shown in FIG. 1 and FIG. 2.

The assistive toilet chair 100 has two auxiliary wheels 60 that are coaxially attached to two outer laterals of the chair frame 10, so that the two auxiliary wheels 60 are close to the front side of the chair frame 10. Particularly, the two auxiliary wheels 60 are each attached to the corresponding brace 13, and the control pedal 41 is arranged between the two auxiliary wheels 60, as shown in FIG. 1 and FIG. 2.

Referring to FIG. 1 and FIG. 6, when the control pedal 41 is not affected by an external force, the movable portion 32 is in the sitting position and combined with the immovable portion 31 for the user 1 to sit thereon.

Referring to FIG. 4, FIG. 6, FIG. 7, and FIG. 8, after the user 1 sitting on the seat 30 finishes defecation and needs a caregiver 3 to help with cleaning, the caregiver 3 can tread the first tread portion 411 of the control pedal 41 to activate the driver 43 to drive the movable portion 32 to pivotally swing upward and move from the sitting position to the standing position. The process of pivotal swing of the movable portion 32 assists the user 1 in standing up. Since the user 1 now has his/her hips 2 exposed at the opening of the movable portion 32, the hips 2 of the user 1 are more accessible to the caregiver 3 without limited by the structure of the seat 30, as shown in FIG. 8, so that the caregiver 3 can easily clean the hips 2 of the user 1 as a part of defecation nursing without additionally moving the user 1.

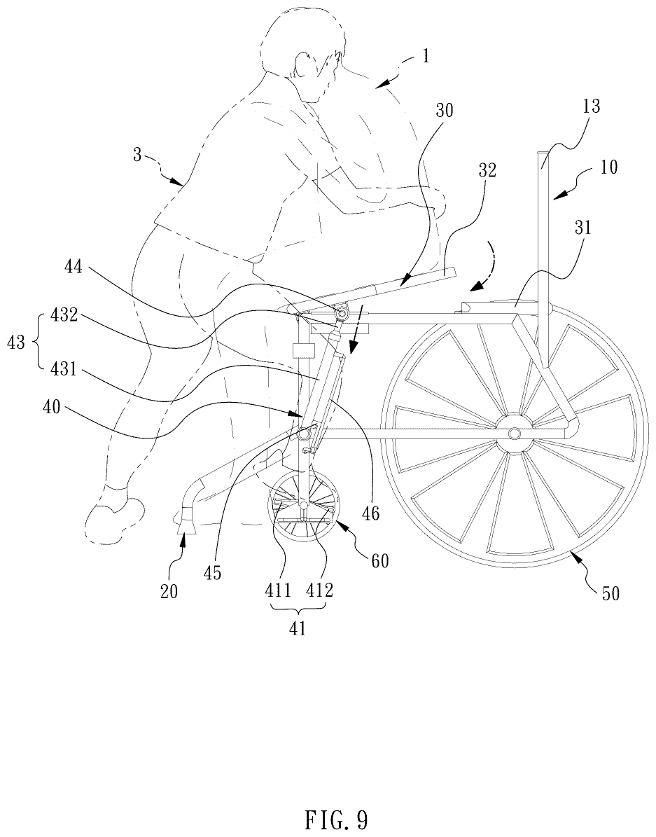

Referring to FIG. 5, FIG. 7, and FIG. 9, after the desired defecation nursing is done, the caregiver 3 can tread the second tread portion 412 of the control pedal 41 to activate the driver 43 to drive the movable portion 32 to pivotally swing downward from the standing position to the sitting position. At this time, the user 1 can sit down slowly with the movable portion 32 due to his/her body weight.

It is to be noted that, in use of the present invention, the caregiver 3 may set the movable portion 32 into the standing position first for the user 1 to lean his/her hips 2 thereon, and then controls the movable portion 32 to enter its sitting position, so that the user 1 can easily and effortlessly sit into the assistive toilet chair 100.

Additionally, the assistive toilet chair 100 of the present invention may be operated by the user 1 on his/her own. When the user 1 sits in the assistive toilet chair 100, the user 1 can tread the control pedal 41 to get assistance in standing up. At this time, since his/her hips 2 are now exposed, he/she can easily clean himself/herself without the interference otherwise caused by the complete seat 30.

To sum up, the assistive toilet chair 100 of the present invention features its separatable movable portion 32 and immovable portion 31, and thereby facilitates the users 1 in standing up and facilitates the caregivers 3 in doing defecation nursing for the users 1.

Meanwhile, the assistive toilet chair 100 of the present invention is simple in structure and easy in operation, making it greatly helpful to the caregivers 3.

The present invention has been described with reference to the preferred embodiments and it is understood that the embodiments are not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

1. An assistive toilet chair, characterized in that the assistive toilet chair comprising:
a chair frame;
a seat, being placed on the chair frame for a user to sit thereon, the seat including an immovable portion and a movable portion, the immovable portion being fixedly connected to a rear side of the chair frame, the movable portion being pivotally connected to a front side of the chair frame, the movable portion and the immovable portion being separatably combined, and the immovable portion and the movable portion being in matching U-like shapes with openings thereof facing each other; and
a controlling device, being attached to the chair frame, the controlling device controlling the movable portion to pivotally swing and move between a sitting position and a standing position; the controlling device having a control pedal, a power source, and a driver, the control pedal being attached to a lower part of the front side of the chair frame and being connected to the power source, and the driver being connected between the power source and the movable portion of the seat, so that when the control pedal is pressed, the controlling device controls the power source to activate the driver to drive the movable portion to pivotally swing, wherein when the movable portion is in the sitting position, the movable portion and the immovable portion combine to form the complete seat for the user to sit thereon, and when the movable portion is in the standing position, the movable portion separates from the immovable portion and props up the user to stand up, so that the user has hips thereof exposed at the opening of the movable portion.

2. The assistive toilet chair of claim 1, wherein the control pedal has a first tread portion and a second tread portion, in which when the first tread portion is pressed, the controlling device controls the power source to activate the driver to drive the movable portion to pivotally swing from the sitting position to the standing position, and when the second tread portion is pressed, the controlling device controls the power source to activate the driver to drive the movable portion to pivotally swing from the standing position to the sitting position.

3. The assistive toilet chair of claim 2, wherein the power source is a pneumatic valve and the driver is a pneumatic cylinder, in which a first tube and a second tube are arranged between the power source and the driver, so that when the first tread portion is pressed, the first tube communicates with the driver, whereby the driver props up the movable portion and the movable portion pivotally swings from the sitting position to the standing position, and when the second tread portion is pressed, the second tube communicates with the driver, whereby the driver makes the movable portion pivotally swing back to the sitting position from the standing position.

4. The assistive toilet chair of claim 3, further comprising a first check valve that is arranged between the power source and the first tube, and a second check valve that is arranged between the power source and the second tube.

5. The assistive toilet chair of claim 4, wherein the control pedal further has a first press member and a second press member, in which the first press member is arranged between the first tread portion and the first check valve, and the second press member is arranged between the second tread portion and the second check valve.

6. The assistive toilet chair of claim 1, further comprising a chair back attached to the rear side of the chair frame, in which the opening of the movable portion faces the chair back.

7. The assistive toilet chair of claim 6, further comprising two primary wheels and two auxiliary wheels, wherein the two primary wheels are coaxially attached to two outer laterals of the chair frame and are close to the rear side of the chair frame, and the two auxiliary wheels are coaxially attached to the two outer laterals of the chair frame and are close to the front side of the chair frame.

8. The assistive toilet chair of claim 7, wherein the chair frame has two braces and a crossbar, and the crossbar has two ends thereof connected to front sides of the two braces, so that the two primary wheels and the two auxiliary wheels are attached to the two braces, respectively, and wherein the movable portion has a bottom surface that is provided with a first hinge and a second hinge, in which the first hinge is located opposite to the opening of the movable portion and is pivotally connected to the crossbar, while the second hinge is pivotally connected to the driver.

9. The assistive toilet chair of claim 8, further comprising a connecting component that is arranged between the driver and the movable portion, and has a universal joint and a link, wherein the universal joint is connected between the driver and the link, and the link is pivotally connected between the universal joint and the second hinge.

10. The assistive toilet chair of claim 1, further comprising two anti-tumble members and two retaining members, each of the anti-tumble members having one end thereon pivotally connected to the front side of the chair frame and an opposite end configured to prop on a ground, and the two retaining members being attached to the front side of the chair frame and close to a top surface of the chair frame, so that the two retaining members fittingly receive the two anti-tumble members.
